(19) United States
(12) Patent Application Publication
(10) Pub. No.: US 2007/0112477 A1
(43) Pub. Date: May 17, 2007

(54) Optimization of a vehicle dynamics control using tire information

(75) Inventors: Anton Van Zanten, Ditzingen (DE); Matthew Nimmo, Ludwigsburg (DE); Michael Stams, Bad Wimpfen/Hohenstadt (DE); Jacky Pineau, Blanzat (FR); Patrice Gauthier, Chappes (FR)

Correspondence Address: KENYON & KENYON LLP, ONE BROADWAY, NEW YORK, NY, 10004, US

(73) Assignees: ROBERT BOSCH GMBH, D-70442 STUTTGART (DE); SOCIETE DE TECHNOLOGIE MICHELIN, F-63000 CLERMONT FERRAND (FR)

(21) Appl. No.: 10/556,105

(22) PCT Filed: May 3, 2004
(86) PCT No.: PCT/DE04/00937

§ 371 Date: Jan. 3, 2007

(30) Foreign Application Priority Data
May 8, 2003 (DE) 103 20 828.3

(51) Int. Cl. G05D 1/00; G06F 17/00

(52) U.S. Cl. 701/2; 701/1; 701/70

(57) ABSTRACT

The present arrangement relates to a method and a device for optimizing the regulation behavior of a vehicle dynamics control in motor vehicles. An improved regulation behavior may be achieved by making available information on a tire property, such as the tire type, the kind of tire, the tire pressure, the tire temperature, the condition of the tire or the age of the tire, and by transmitting the tire information to a device of a vehicle dynamics control, where it is taken into account by the latter for the regulation.

### FIELD OF THE INVENTION

The present invention relates to a method for optimizing the control response of a vehicle dynamics control.

### BACKGROUND INFORMATION

Vehicle dynamics controls, among which, below, are understood to be all systems intervening in vehicle operation, such as ABS (antilock brake system), ASR (traction control system), ESP (electronic stability program) or MSR (engine-drag-torque control) increase controllability of motor vehicles in borderline situations. In this context, in particular, the electronic stability control system ESP prevents skidding of the vehicle.

### SUMMARY OF THE INVENTION

In the vehicle dynamics controls named, ordinarily, the wheel slip acting on one wheel forms the controlled variable. In this context, wheel slip is controlled in such a way that the vehicle demonstrates driving properties adapted optimally to the driver's command (brakes, acceleration, cornering, etc) and to the roadway without going out of control. The wheel slip occurring at one wheel is essentially a function of the condition of the roadway and especially of the tire that is mounted. At the same contact patch force, a worn tire will experience a greater slip than a new tire. Then, too, the slip may differ substantially between summer and winter tires.

In the known vehicle dynamics controls, algorithms are used to calculate a setpoint variable, such as a setpoint slip or a setpoint yaw moment, and they are designed for an average tire. Therefore, the algorithms mostly do not work in optimum fashion for the tire that is actually mounted. The result is an insufficient control response of the vehicle dynamics control in borderline situations, especially in response to serious changes in the tire properties, such as a badly worn or flat tire. In these situations, the known vehicle dynamics controls are right up against their limits.

It is therefore the object of the present invention to optimize a vehicle dynamics control in such borderline situations.

The essential thought behind the present invention is to make available information about a tire property (including also a variable derived from this) such as the tire pressure, the kind of tire (summer or winter tire, spare tire) or the type of tire (model number), and to transmit this to a device of the vehicle dynamics control which takes this tire information into consideration during the control.

The tire information is preferably transmitted to a device, preferably a control unit, in which the regulation algorithm for carrying out the vehicle dynamics control is stored. The regulation algorithm has at least one parameter that is a function of the tire. Then the parameter or parameters may be selected by the tire information, and the vehicle dynamics control may consequently be adapted to the current tire condition.

The vehicle dynamics control essentially includes a control unit, a sensor system for ascertaining the current actual value of various state variables, and at least one actuator as the actuating mechanism of the regulation. The regulating function is implemented as software in the control unit and is used, for example, to calculate a setpoint slip or setpoint yaw moment. The parameters of the algorithm that depend on the tires may be appropriately adjusted if tire information is known.

Preferably, a transmitting device situated in the tire is provided for transmitting the tire information. The tire information may also optionally be supplied from outside the vehicle, using, for instance, a service computer.

The tire property that is taken into consideration by the vehicle dynamics control is preferably at least one property from the group made up of the tire type (the model), the kind of tire (summer or winter tire, spare tire), the tire pressure, the tire temperature, the tire condition and the age of the tire. The tire type or the age of the tire (date of manufacture) may, for example, be stored in a memory device on the tire, and be transmitted in contactless fashion to the vehicle dynamics control. The tire pressure, the tire temperature and the condition of the tire may be measured using an appropriate sensor system and may also be transmitted, particularly in contactless fashion, to the vehicle dynamics control. Knowing one or more tire properties makes possible an optimum adaptation of the vehicle dynamics control to the current tire type and the condition of the tire.

According to one preferred specific embodiment of the present invention, the tire pressure is monitored using a suitable sensor system, and when a specified tire pressure is undershot, a tire-dependent parameter (or a whole set of parameters) is adapted to this state. This makes it possible to detect a “flat tire”, and to take this state into consideration in the vehicle dynamics control, particularly during a braking procedure.

When using tires having flat-running properties (designated from here on as flat-running tires), the regulation algorithm is preferably implemented in such a way that it may assume at least two discrete states, as a function of whether one of the flat-running tires is in normal operation (normal tire pressure) or in flat-running operation (flat tire). Flat-running tires (English: “runflat tires”) are constructed so that, even at a total loss of pressure, one may still continue to drive them for a limited distance, and particularly not have them slide off the rim. In the case of one known type of tire, the weight of the vehicle in runflat operation is carried by a support ring which is located in the tire. Another type of tire has reinforced sidewalls, which do not completely buckle in response to pressure loss, and especially are not destroyed by it.

The discrete tire state (normal state or runflat state) may be detected by sensor monitoring of the tire pressure, and correspondingly, a discrete set of parameters may be selected for the regulation algorithm. In a four-wheel vehicle, the vehicle dynamics controller may assume several, preferably five discrete states, such as:
all tires normal
front left tire in runflat operation
front right tire in runflat operation
rear left tire in runflat operation
front right tire in runflat operation

The runflat tires of various manufacturers or different types usually have different running properties in runflat operation, and distinguish themselves in the transverse force the tire is able to absorb. Therefore, the regulation algorithm is preferably adapted at least to the type of tire and the tire state (normal operation or runflat operation

### BRIEF DESCRIPTION OF THE DRAWINGS

FIG. 1 shows a schematic representation of a vehicle dynamics control system (ESP) for attitude angle regulation and yaw velocity regulation according to the related art.

FIG. 2 shows a graph for determining the setpoint slip as a function of the coefficient of static friction.

FIG. 3 shows a graph for determining the free roll velocity of a tire.

FIG. 4 shows a graph of the lateral force acting on a tire as a function of the braking force and the tire slip angle of the tire.

FIG. 5 shows a graph of the yaw rate as a function of the vehicle speed and the steering angle.

### DETAILED DESCRIPTION

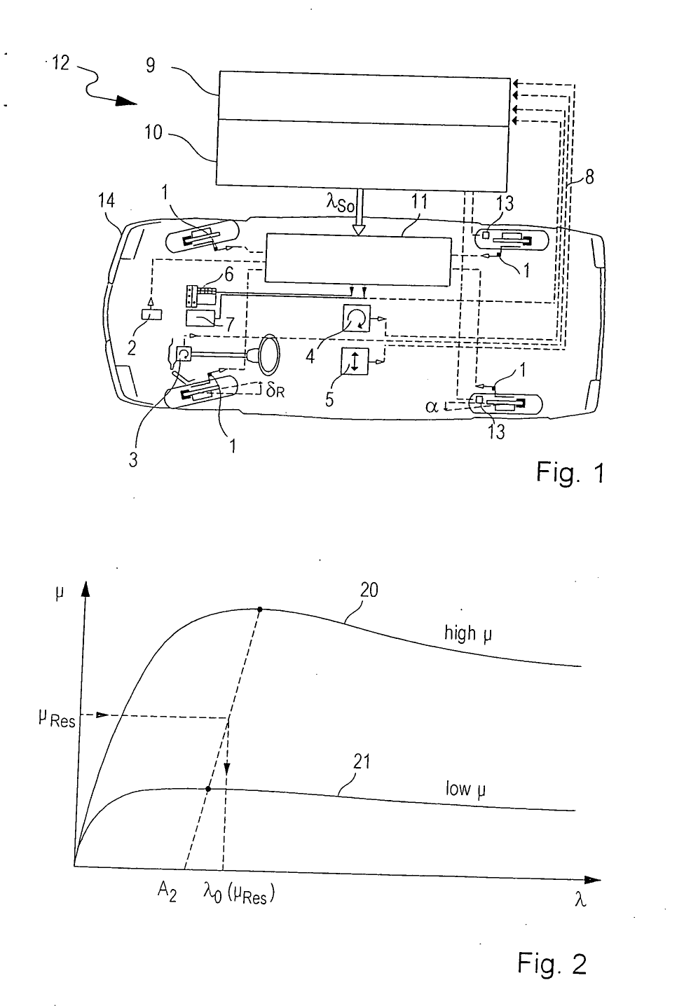

FIG. 1 shows the overall regulating system of a vehicle dynamics control (ESP) for carrying out an attitude angle regulation and a yaw rate regulation. The overall system includes vehicle 14 as the controlled system, sensors 1-5 for determining the control input quantities, actuators 6, 7 for influencing braking forces and drive forces, as well as a hierarchically structured controller 10, 11, made up of a superposed vehicle dynamics controller 10 and a subordinate traction control system 11. For the regulation of the attitude angle and the yaw rate, superposed controller 10 specifies setpoint values in the form of setpoint slip λ_{No} to traction control system 11. Assessor 9 ascertains the regulated state variable (attitude angle μ). Assessor 9, vehicle dynamics controller 10 and traction control system 11 are components of a control unit 12.

In order to determine the setpoint behavior, the signals describing the driver's command of steering wheel angle sensor 3 (steering command), of admission pressure sensor 2 (deceleration command) of engine management 7 (drive torque command) are evaluated. Additionally, the calculation of the setpoint behavior also involves the coefficients of static friction and the vehicle speed, which are estimated from the signals of wheel revolution sensors 1, transverse acceleration sensors 5, yaw rate sensor 4 and admission pressure sensor 2. As a function of the system deviation, the yawing moment is calculated, which is required for adjusting the actual state variables to the setpoint state variables.

For the generation of this yawing setpoint value, the required setpoint slips for the individual wheels are ascertained in vehicle dynamics controller 10. These are set via subordinate braking and traction control system 11 and actuators “braking hydraulics” 6 and “engine management” 7.

In order to be able to take into consideration the tire condition in the vehicle dynamics control, regulating system 1-12 includes a tire sensor system 13 situated in the wheels, which measures a tire property such as the tire pressure or the state of wear, and transmits a corresponding value to the control unit. The vehicle dynamics control is able to take into consideration the tire information received in a different way.

1. Determination of Working Point λ₀

In order to calculate setpoint slip λ_{No}, the μ/slip curve shown in FIG. 2 is used as the basis. In this context, it is assumed that the μ/slip curve is linear at small slip values λ, and has a maximum at a value λ₀ (the so-called working point), which is a function of the coefficient of static friction of the roadway. Curve 20 shows the curve of the slip under good static friction conditions, such as on a dry roadway, and curve 21 shows the slip curve at low coefficients of friction, such as on a wet roadway. As may be seen, substantially more force may be transmitted (higher μ value) in response to a dry roadway (curve 20) at the same slip. For working point λ₀, there results the following relationship, according to a first approximation:

$${λ}_{0} ( {μ}_{res} ) = {A}_{2} + {A}_{0} * {μ}_{res} + \frac{{A}_{1}}{{v}_{whlFre}} \\ where \\ {μ}_{res} = \frac{\sqrt{{F}_{L}^{2} + {F}_{Q}^{2}}}{{F}_{N}} , \qquad ( 1 )$$

In this context, parameters A₀, A₁ and A₂ are tire-dependent parameters which may be set as a function of the tire information. The value v_{whlFre} is the free roll velocity (slip-free speed) of the tire. The quantities F_{L} and F_{Q} designate the longitudinal and transverse forces acting on the tire. F_{N} is the normal force or vertical tire force.

According to a first specific embodiment of the present invention, at least one tire property, such as the tire type, tire pressure or the state of the tire, is transmitted to vehicle dynamics controller 10, and there, corresponding values are selected for parameters A₀, A₁ and A₂. Optionally, one may also transmit to regulating unit 10 tire-dependent parameters A₀, A₁, A₂ themselves or a value for λ₀, for instance, as a function of coefficient of friction μᵣₑₛ.

The transmission of the tire information may be carried out, for example, in a contactless manner, from tire to control unit 10. Optionally, an updating of the tire data could take place, for instance, in response to a tire change or during a service via a service computer that would update the tire-dependent variables in control unit 12.

2. Determination of the Free Roll Velocity v_{whlFre}

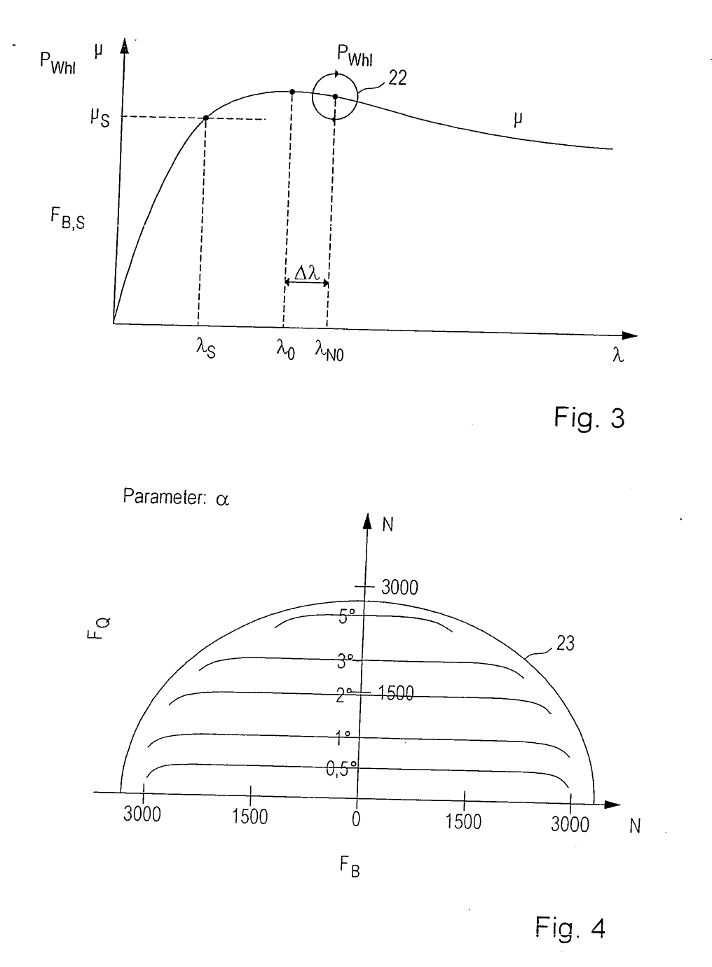

The free roll velocity v_{whlFre} of the tire that appears in equation (1) is also a tire-dependent quantity. This is determined particularly by the longitudinal tire stiffness C_{λ}. In order to estimate the free roll velocity of tire v_{whlFre}, the modulation of the braking pressure is interrupted during a braking procedure, and the braking pressure is held for a short period of time to a constant, low value. This is shown graphically in FIG. 3.

FIG. 3 shows a μ/slip curve in whose upper section the modulation of the braking pressure is shown symbolically by a circle for the setting of the wheel slip to its setpoint value λ_{No}. In order to estimate the free roll velocity v_{whlFre} of the tire, the pressure modulation is interrupted, and the wheel pressure is held for a short period of time to a low, constant value. After a resting stage, the stable slip value λ_{S} has set in, which is in the linear range of the μ/slip curve. While using a linear connection between the stable slip value λₛ and the longitudinal stiffness of tire C_{λ}, free roll velocity V_{whlFre} of the tire may be estimated in a simple manner. Then it is true that
μ_{S}=C_{λ}*λ_{S}bzw.λ_{S}=μ_{S}/C_{λ}
Substituting

$${λ}_{S} = 1 - \frac{{v}_{Whl , S}}{{v}_{Whlfre}} ,$$

it follows that

$$\frac{{v}_{Whl , S}}{{v}_{Whlfre}} = 1 - {μ}_{S} / {C}_{λ} = \frac{{C}_{λ} - {μ}_{S}}{{C}_{λ}} ,$$

and consequently

$${v}_{Whlfre} = {v}_{Whl , S} * \frac{{C}_{λ}}{{C}_{λ} - {μ}_{S}} = {v}_{Whl , S} \cdot \frac{{C}_{λ}}{{C}_{λ} - \frac{{F}_{L , S}}{{F}_{N}}}$$

The values for C_{λ}, in turn, may be selected as a function of the tire property(ies) that are at hand. Optionally, a value derived from the tire property, such as a value for C_{λ} or v_{whlFre}, may be transmitted to the vehicle dynamics control, which is processed directly by control unit 12.

3. Determination of the Tire Transverse Force F_{Q}

The lateral or transverse force F_{Q} of the tire needed for the estimation of the resulting coefficient of static μᵣₑₛ is also a function of the current tire. FIG. 4 shows the transverse force F_{Q} as a function of the braking force F_{B} and tire slip angle α of the tire. As may be seen, envelope 23 forms a friction ellipse. It follows from the friction ellipse that

$${F}_{Q} = c * α * \frac{\sqrt{{F}_{L}^{2} + {F}_{Q}^{2}}}{\sqrt{{λ}^{2} + {c}^{2} \cdot {α}^{2}}} ,$$

where c=C_{α}/C_{λ}
For λ not equal to zero, we have

$${F}_{Q} = \frac{{C}_{α}}{{C}_{λ}} \cdot \frac{α}{λ} {F}_{L}$$

In this context, C_{α} is the transverse stiffness of the tire.

To determine the transverse force F_{Q} or the resulting coefficient of static friction μᵣₑₛ, in turn, a tire information such as the tire type, the condition of the tire or the manufacturing date of the tire may be directly taken into account, or a value derived from it, such as the transverse stiffness of the tire C_{α} may be transmitted to control unit 10.
4. Determination of the Setpoint Yaw Velocity The setpoint yaw velocity d_{ψNo}/dt is usually calculated according to the so-called “single track model”. For this it is true that

$$ⅆ {ψ}_{No} / ⅆ t = \frac{{v}_{x}}{l \cdot ( 1 + \frac{{v}_{x}^{2}}{{v}_{{ch}^{2}}} )} * {δ}_{w}$$

δ_{w} being the average steering angle at the front wheels, vₓ being the longitudinal speed of the vehicle and v_{ch} being the characteristic speed of the vehicle. The value of the characteristic speed v_{ch}, in turn, is a function of a tire property, namely the longitudinal stiffness of the tire.
Then it is true that

$$1 / {v}_{{ch}^{2}} = \frac{m}{{I}^{2}} * ( \frac{{l}_{r} \cdot {C}_{α r} - {l}_{f} \cdot {C}_{α f}}{{C}_{α f} \cdot {C}_{α r}} )$$

In this case the quantities C_{αf} and C_{αr} designates the entire transverse stiffness of the vehicle at the front and the rear axle. The parameter m denotes the vehicle mass, I_{f} and Iᵣ denote the distance of the front or rear axle from the center of gravity of the vehicle, and I denotes the distance between the front and rear axles.

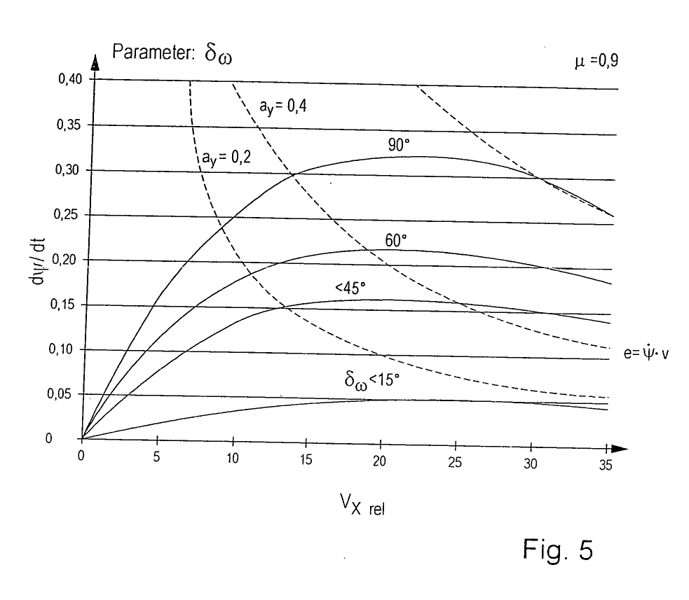

FIG. 5 shows the yaw velocity d_{ψ}/dt plotted against the vehicle speed v_{X} as a function of various steering angles δ_{W} according to the single-track model. The transverse stiffness of the tires included therein varies with the type of tire (winter tire/summer tire, spare tire, etc) and the condition of the tire (wear, pressure, temperature, etc). In order to take into consideration the current tire, either tire information from which a value for C_{α} may be determined, or a value derived therefrom, such as the lateral tire stiffness C_{α} itself, is transmitted to control unit 10 of the vehicle dynamics control.

6. Taking into Consideration Tire Information in an ABS Braking Procedure with μ-Split

In a vehicle dynamics control (ESP), an ABS braking procedure with μ-split (on the left side of the vehicle the coefficient of static friction is different from what it is on the right side of the vehicle) is handled as a special situation. In order to keep the vehicle under control, the braking force on the side having the high static friction value is raised only slowly above the braking force on the side having the low static friction value, only one predefined maximum difference between the braking moment acting on the left vehicle side and that on the right vehicle side being allowed, Thereby the driver has sufficient time to steer against the appearing yaw moment and to stabilize the vehicle. To optimize the regulating behavior of a vehicle dynamics control, in such a driving situation (braking with μ-split), a tire property or a value derived therefrom is also transmitted to control unit 12. Especially in the case of a flat tire on the high μ side, which, because it lacks tire pressure, has a higher roll resistance than a tire that is intact, the regulating behavior of the vehicle dynamics control may be appropriately adapted. For this, for example, the pressure buildup of the braking pressure on the side having the high friction value may be carried out using lower gradients, and/or the maximum pressure difference between the side having the high friction value and the side having the low friction value may be limited to a lower value.

7. Setting the Regulator Parameters

Traction control system 11 of the vehicle dynamics control usually includes a PID slip regulator for regulating the setpoint Slip λ_{No}. If the μ/slip curve (see FIG. 2) has a very dominant maximum, then, for example, the strengthening of the PID regulator (the strengthening of the P, I and/or D part) may be increased and vice versa. The characteristics of the μ/slip curve may change, for example, due to wear or low tire pressure. The change of a tire property may be taken into account by a corresponding change of the regulator strengthening.

8. Selection of the Wheels for Setting the Yawing Moment of the Vehicle

If a tire property, such as the tire pressure, changes so greatly that the corresponding value exceeds predefined boundaries, the selection of those wheels may also be changed which are regulated for the application of a yawing moment. During cornering of a freely rolling vehicle, for instance, braking slip interventions at the front inside wheel are usually not permitted. However, if the vehicle is greatly understeering, because the front outside wheel has too little tire pressure, a slip regulation at the front inside wheel may also be admissible. Thus, basically any selection of a wheel to be controlled may be made as a function of tire information.

9. Adaptation of the Regulation Algorithm When Using Runflat Tires

When using tires having runflat properties, the regulation algorithm is implemented in such a way that it may assume at least two discrete states, as a function of whether one of the runflat tires is in normal operation (normal tire pressure) or in runflat operation (flat tire). Flat-running tires (English: “runflat tires”) are constructed so that, even at a total loss of pressure, one may still continue to drive them for a limited distance, and at a reduced speed. To ensure this, it is known that one may provide a supporting ring fastened at the rim, on which the cord casing sits. When there is a pressure loss, this supporting ring bears the load. Another type of runflat tire may have, for instance, reinforced sidewalls that are not destroyed when there is a pressure loss, so that the tire does not slide of the rim.

By monitoring of the tire pressure, the tire state (normal state or runflat state) may be detected, and correspondingly, a discrete set of parameters may be selected for the regulation algorithm. The vehicle dynamics controller may, for example, assume five discrete states:
all tires normal
front left tire in runflat operation
front right tire in runflat operation
rear left tire in runflat operation
front right tire in runflat operation

Each of the states corresponds to a discrete setting of various parameters (e.g. tire stiffness, rolling speed, tire forces, etc), as explained in exemplary fashion in the above points 1 through 8. The regulation algorithm may consequently be adapted to the respective tire state.

1-13. (canceled)

14. A method for optimizing a regulation behavior of a vehicle dynamics control in a motor vehicle, comprising:
making available tire information;
transmitting the tire information to a device of the vehicle dynamics control; and
carrying out the vehicle dynamics control as a function of the tire information, wherein:
a regulation algorithm of the vehicle dynamics control assumes one of several discrete states in response to the use of runflat tires, as a function of whether one of the runflat tires is in one of a normal operation and in a runflat operation.

15. The method as recited in claim 14, further comprising:
selecting at least one parameter of the regulation algorithm as a function of the tire information.

16. The method as recited in claim 14, wherein the tire information includes at least one of a tire type, a kind of tire, a tire pressure, a tire temperature, a tire state, and an age of the runflat tire.

17. The method as recited in claim 14, further comprising:
measuring a tire property via a tire sensor system; and
transmitting the corresponding tire information to the device.

18. The method as recited in claim 14, further comprising:
within a scope of the vehicle dynamics control, executing another algorithm for calculating a setpoint slip, in which at least one parameter is selected as a function of the tire information.

19. The method as recited in claim 14, further comprising:
within a scope of the vehicle dynamics control, executing another algorithm for calculating one of a setpoint yawing moment and a setpoint yaw rate, in which at least one parameter is selected as a function of the tire information.

20. The method as recited in claim 14, further comprising:
monitoring a tire pressure by a sensor system; and
when a predefined tire pressure is undershot, changing at least one parameter of another algorithm of the vehicle dynamics control.

21. A device for a vehicle dynamics control having optimized regulation behavior, comprising:
a first device for making available and transmitting tire information to a second device of the vehicle dynamics control, the second device taking into account the tire information in a regulation, wherein:
a regulation algorithm of the vehicle dynamics control is implemented in such a way that, in response to a use of a runflat tire, the regulation algorithm is able to assume a plurality of discrete states, as a function of whether one of a plurality of runflat tires is one of in a normal operation and in a runflat operation.

22. The device as recited in claim 21, wherein the regulation algorithm includes at least one parameter that is a function of the tire information.

23. The device as recited in claim 21, further comprising:
a sensor system for ascertaining and making available the tire information, wherein the tire information includes at least one of a tire type, a kind of tire, a tire pressure, a tire temperature, a tire state, and an age of the tire.

24. The device as recited in claim 23, wherein the sensor system is situated in the runflat tire.
